(19) United States
(12) Patent Application Publication
(10) Pub. No.: US 2016/0325564 A1
(43) Pub. Date: Nov. 10, 2016

(54) RECORDING APPARATUS

(71) Applicant: SEIKO EPSON CORPORATION, Tokyo (JP)

(72) Inventors: Satoshi YOSHINO, Matsumoto-shi (JP); Sho ARUGA, Chino-shi (JP)

(21) Appl. No.: 15/138,839

(22) Filed: Apr. 26, 2016

(30) Foreign Application Priority Data
May 7, 2015 (JP) 2015-094663

(51) Int. Cl. B41J 11/04

(52) U.S. Cl. CPC B41J 11/04; B41J 2/01

(57) ABSTRACT

A recording apparatus includes a recording head configured to record on a target recording medium, a shaft member that is extended in a direction intersecting with a transportation direction of the target recording medium and is rotatable with both end portions thereof being supported by bearings, a roller for nipping the target recording medium between the shaft member and the stated roller, and pressing members that are provided at appropriate intervals in the direction intersecting with the transportation direction, press the shaft member between the bearings, and maintain the shaft member to be in a deformed state being arched toward an upstream or downstream side of the transportation direction. At least one of the plurality of pressing members biases the shaft member in a direction resisting a load applied from the roller.

### BACKGROUND

1. Technical Field

The present invention relates to recording apparatuses configured to print on a target recording medium.

In this application of the invention, the recording apparatuses include various types of apparatuses such as a serial printer configured to print with a recording head moving in a predetermined direction, a line printer whose recording head does not move, and a copier as well as a facsimile having the above-mentioned printer functions.

2. Related Art

In existing recording apparatuses, a transportation unit for transporting a target recording medium to a recording unit with precision has been provided. As an example of the above-mentioned transportation unit for transporting a target recording medium with precision, such a unit can be cited that includes a pair of rollers; the stated pair of rollers includes a driving roller which drives in a rotatable manner and a pressing roller (slave roller) which presses the target recording medium between the driving roller and the pressing roller to transport the target recording medium.

In the above transportation unit, the driving roller is configured as a shaft member and drives in a rotatable manner with both end portions thereof being pivotally supported by bearings. However, there is a risk that an intermediate portion of the driving roller in a shaft line direction thereof is bent, due to a load applied from the pressing roller, in a direction in which the above load acts. As such, there is provided a recording apparatus having a configuration in which the above-mentioned intermediate portion of a driving roller is supported by a support member or the like, as disclosed in JP-A-2013-256127.

In the recording apparatus disclosed in JP-A-2013-256127, both ends of a cylinder-like transportation roller are pivotally supported on a frame main body configuring the recording apparatus. Further, a pushing member is attached to a lower portion of a guide member for guiding a carriage. A fulcrum portion to make contact with the lower portion of the guide member is provided on the pushing member. The pushing member is so configured as to be capable of rotating relative to the guide member with the fulcrum portion as a fulcrum. One end portion of the pushing member is in contact with a center portion of the transportation roller in a shaft direction of the transportation roller. In addition, a spring is attached between the guide member and the other end portion of the pushing member, and this spring biases, via the pushing member, the center portion of the transportation roller in a transportation direction of the above-mentioned target recording medium and also in a direction resisting a load applied from the above-mentioned pressing roller.

In a recording apparatus disclosed in JP-A-2014-195883, a V-shape support member supports substantially a center portion of a cylinder-like roller. Two coil springs are attached to the support member, for example, and one coil spring biases the roller, via the support member, toward a transportation direction upstream side, while the other coil spring biases the support member in a direction resisting a load applied from a pressing roller that makes contact with and presses the above-mentioned roller.

In other words, because the support members discussed above support the center portion of the transportation roller in the shaft line direction thereof, in the case where the transportation roller exhibits a swing, when the transportation roller is rotated, in which the center portion thereof takes a peak position in a rotational swing (U-shape swing), the swing of the transportation roller can be suppressed. This makes it possible to suppress deterioration in recording quality of the target recording medium due to a decreased transportation precision of the target recording medium.

However, in the transportation rollers manufactured from pipe shafts by press processing, there are variations in shape, precision of dimensions, and so on that are generated during the manufacturing; particularly, in the case of a recording apparatus in which large-size paper such as A3 size paper or the like is transported, a state in which the above-mentioned rotational swing is at its peak between the support member and a bearing pivotally supporting one of the end portions of the transportation roller in the shaft line direction of the transportation roller (S-shape swing), a state in which the rotational swing of the transportation roller is at its peak on both sides of the support member in the shaft line direction (W-shape swing), or the like is generated in some case when the transportation roller is rotated. In such case, the support member cannot suppress the rotational swings so that the transportation precision of the target recording medium deceases. In the target recording medium, unevenness in image quality of the target recording medium is generated as a result due to the decrease in the transportation precision, which raises a risk that the recording quality of the target recording medium is deteriorated.

### SUMMARY

An advantage of some aspects of the invention is to provide a recording apparatus capable of suppressing decrease in transportation precision of a target recording medium.

In order to solve the above problems, a recording apparatus according to a first aspect of the invention includes a recording head configured to record on a target recording medium, a shaft member that is extended in a direction intersecting with a transportation direction of the target recording medium and is rotatable with both end portions thereof being supported by bearings, a roller for nipping the target recording medium between the shaft member and the stated roller, and regulating members that are provided at appropriate intervals in the direction intersecting with the transportation direction and regulate a shape of the shaft member between the bearings to be in a deformed state being arched toward an upstream or downstream side of the transportation direction.

According to this aspect, because the plurality of regulating members are provided at appropriate intervals in the direction intersecting with the transportation direction and regulate the shape of the shaft member between the bearings to be in a deformed state being arched toward the upstream or downstream side of the transportation direction, in the case where the shaft member is rotated, a rotational swing generated in the shaft member, particularly a rotational swing in the transportation direction can be suppressed or corrected with the plurality of regulating members.

That is, the spirit of the invention is not to suppress deformation of the shaft member; in other words, the invention is configured such that the shaft member is deformed in advance and this deformed state is maintained, thereby suppressing the rotational swing.

Because the plurality of regulating members are provided at appropriate intervals along the shaft line direction of the shaft member, even if the peak of the rotational swing of the shaft member may be present at any position in the shaft line direction of the shaft member, the peak of the rotational swing can be lowered or corrected with the plurality of regulating members. As a result, since the rotational swing of the shaft member during rotation thereof can be made smaller, the transportation precision of the target recording medium can be maintained and the recording quality of the target recording medium can be maintained as well.

A recording apparatus according to a second aspect of the invention includes a recording head configured to record on a target recording medium, a shaft member that is extended in a direction intersecting with the transportation direction of the target recording medium and is rotatable with both end portions thereof being supported by bearings, a roller for nipping the target recording medium between the shaft member and the stated roller, and pressing members that are provided at appropriate intervals in the direction intersecting with the transportation direction, press the shaft member between the bearings, and maintain the shaft member to be in a deformed state being arched toward the upstream or downstream side of the transportation direction.

According to this aspect, because the plurality of pressing members are provided at appropriate intervals in the direction intersecting with the transportation direction, press the shaft member between the bearings, and maintain the shaft member to be in a deformed state being arched toward the upstream or downstream side of the transportation direction, in the case where the shaft member is rotated, a rotational swing generated in the shaft member, particularly a rotational swing in the transportation direction can be suppressed or corrected with the plurality of pressing members. As a result, since the rotational swing of the shaft member during rotation thereof can be made smaller, the transportation precision of the target recording medium can be maintained and the recording quality of the target recording medium can be maintained as well.

That is, the spirit of the invention is not to suppress the deformation of the shaft member; in other words, the invention is configured such that the shaft member is deformed in advance and this deformed state is maintained, thereby suppressing the rotational swing.

A recording apparatus according to a third aspect of the invention includes a recording head configured to record on a target recording medium, a shaft member that is extended in a direction intersecting with the transportation direction of the target recording medium and is rotatable with both end portions thereof being supported by bearings, a roller for nipping the target recording medium between the shaft member and the stated roller, and pressing members that are provided at appropriate intervals in the direction intersecting with the transportation direction and press the shaft member to shift a rotational center position of the shaft member at pressurized sections toward the upstream or downstream side of the transportation direction relative to a rotational center position thereof at sections of the bearings.

According to this aspect, because the plurality of pressing members are provided at appropriate intervals in the direction intersecting with the transportation direction and press the shaft member to shift a rotational center position of the shaft member at the pressurized sections toward the upstream or downstream side of the transportation direction relative to a rotational center position thereof at the bearing sections, in the case where the shaft member is rotated, a rotational swing generated in the shaft member, particularly a rotational swing in the transportation direction can be suppressed or corrected with the plurality of pressing members. As a result, since the rotational swing of the shaft member during rotation thereof can be made smaller, the transportation precision of the target recording medium can be maintained and the recording quality of the target recording medium can be maintained as well.

That is, the spirit of the invention is not to suppress the deformation of the shaft member; in other words, the invention is configured such that the shaft member is deformed in advance and this deformed state is maintained, thereby suppressing the rotational swing.

A recording apparatus according to a fourth aspect of the invention includes a recording head configured to record on a target recording medium, a shaft member that is extended in a direction intersecting with the transportation direction of the target recording medium and is rotatable with both end portions thereof being supported by bearings, a roller for nipping the target recording medium between the shaft member and the stated roller, and a plurality of pressing members that are so provided as to correspond to positions where a swing of the shaft member during rotation thereof becomes large in the direction intersecting with the transportation direction, and press the shaft member toward the upstream or downstream side of the transportation direction.

According to this aspect, because the plurality of pressing members are so provided as to correspond to the positions where a swing of the shaft member during rotation thereof becomes large in the direction intersecting with the transportation direction and press the shaft member toward the upstream or downstream side of the transportation direction, in the case where the shaft member is rotated, a rotational swing generated in the shaft member, particularly a rotational swing in the transportation direction can be suppressed or corrected with the plurality of pressing members. As a result, since the rotational swing of the shaft member during rotation thereof can be made smaller, the transportation precision of the target recording medium can be maintained and the recording quality of the target recording medium can be maintained as well.

That is, the spirit of the invention is not to suppress the deformation of the shaft member; in other words, the invention is configured such that the shaft member is deformed in advance and this deformed state is maintained, thereby suppressing the rotational swing.

A recording apparatus according to a fifth aspect of the invention is such that, in any one of the second through fourth aspects, at least one of the plurality of pressing members biases the shaft member in a direction resisting a load applied from the above-mentioned roller.

A recording apparatus according to a sixth aspect of the invention is such that, in any one of the second through fifth aspects, the plurality of pressing members include a first pressing member positioned approximately at the center between the bearings and second pressing members positioned on both sides of the first pressing member in the direction intersecting with the transporting direction; the first pressing member presses the shaft member toward the upstream or downstream side of the transportation direction and also presses the shaft member in a direction resisting a load applied from the roller; the second pressing members press the shaft member toward the upstream side of the transportation direction in the case where the first pressing member presses the shaft member toward the upstream side of the transportation direction, and press the shaft member toward the downstream side of the transportation direction in the case where the first pressing member presses the shaft member toward the downstream side of the transportation direction.

According to this aspect, the first pressing member presses the shaft member toward the upstream or downstream side of the transportation direction and also presses the shaft member in a direction resisting a load applied from the roller, and the second pressing members press the shaft member toward the upstream or downstream side of the transportation direction. That is, only the first pressing member presses the shaft member in a direction resisting the load. In this aspect, the load from the roller that acts on the shaft member and a pressing force with which the first pressing member presses the shaft member are so set as to be balanced with each other in the direction resisting the load, which will be explained in detail later. As a result, because the load applied from the roller and the pressing force applied from the pressing member are balanced with each other in the shaft member, a position for nipping between the shaft member and the roller can be maintained to be constant in the direction resisting the load. Consequently, a distance from the aforementioned recording head to the target recording medium can be maintained to be constant in the direction resisting the load, thereby making it possible to maintain the recording quality of the target recording medium.

A recording apparatus according to a seventh aspect of the invention is such that, in the third aspect, the plurality of pressing members include a first pressing member positioned approximately at the center between the bearings and second pressing members positioned on both sides of the first pressing member in the direction intersecting with the transporting direction.

A recording apparatus according to an eighth aspect of the invention is such that, in any one of the second through seventh aspects, the recording apparatus further includes a bias unit configured to bias at least one of the plurality of pressing members toward the upstream or downstream side of the transportation direction and a contact portion configured to make contact with the pressing member biased by the bias unit so as to regulate a position of the stated pressing member in the transportation direction; the bias unit maintains a state in which the pressing member is in contact with the contact portion.

According to this aspect, because a bias unit maintains the state in which the pressing member is in contact with the contact portion, the rotational swing of the shaft member can be more surely suppressed, the decrease in transportation precision of the target recording medium in the transportation direction can be suppressed, and the recording quality of the target recording medium can be maintained.

A recording apparatus according to a ninth aspect of the invention is such that, in the third or fourth aspect, a detection unit for detecting the rotation of the shaft member is provided at one end portion of the shaft member, and at least one of the plurality of pressing members is provided between the detection unit and the bearing that supports the above one end portion of the shaft member.

According to this aspect, because a detection unit for detecting the rotation of the shaft member is provided at one end portion of the shaft member, and at least one of the plurality of pressing members is provided between the detection unit and the bearing that supports the one end portion of the shaft member, the rotational swing of the one end portion of the shaft member is suppressed with the stated pressing member so that a decrease in detection precision of the detection unit can be suppressed.

A recording apparatus according to a tenth aspect of the invention is such that, in any one of the first through ninth aspects, the shaft member includes, in the direction intersecting with the transportation direction, a high friction portion that makes contact with the target recording medium and transports the target recording medium using a frictional force generated between the target recording medium and the high friction portion, and a low friction portion having a lower friction coefficient than the high friction portion and making contact with the pressing member; the pressing member presses the low friction portion.

According to this aspect, the shaft member includes, in the direction intersecting with the transportation direction, a high friction portion that makes contact with the target recording medium and transports the target recording medium using a frictional force generated between the target recording medium and the high friction portion, and a low friction portion having a lower friction coefficient than the high friction portion and making contact with the pressing member; and the pressing member presses the low friction portion. Because of this, in the case where the shaft member is rotated, sliding resistance between the low friction portion of the shaft member and the pressing member can be reduced, the shaft member can be smoothly rotated, and the transportation of the target recording medium can be carried out smoothly with the shaft member. As a result, a variation in transportation precision of the target recording medium in the transportation direction can be suppressed, whereby the recording quality of the target recording medium can be maintained.

A recording apparatus according to an eleventh aspect of the invention is such that, in the sixth aspect, the first pressing member includes a first slope that extends toward the upstream side of the transportation direction and also extends in a direction resisting the aforementioned load, and a second slope that extends toward the downstream side of the transportation direction and also extends in the direction resisting the load; the first slope and the second slope make contact with the shaft member and support the shaft member in the direction resisting the load, and one of the first slope and the second slope presses the shaft member toward the upstream or downstream side of the transportation direction.

### BRIEF DESCRIPTION OF THE DRAWINGS

The invention will be described with reference to the accompanying drawings, wherein like numbers reference like elements.

FIG. 1 is an exterior appearance perspective view of a printer according to the invention.

FIG. 2 is a cross-sectional side view illustrating a paper transportation path of a printer according to the invention.

FIG. 3 is a perspective view illustrating a frame of a printer according to a first embodiment.

FIG. 4 is a plan view illustrating a relationship between a transportation roller and a support member according to the first embodiment.

FIG. 5 is a perspective view illustrating a relationship between a transportation roller and a support member according to the first embodiment.

FIG. 6A is a perspective view illustrating a first support member supporting a center portion of a transportation roller, and FIG. 6B is a perspective view illustrating a second support member supporting the transportation roller on both sides of the center portion of the transportation roller.

FIG. 7 is a plan view illustrating a state of a transportation roller supported by bearings and support members.

FIG. 8 is a cross-sectional view taken along a VIII-VIII line in FIG. 4.

FIG. 9A is a cross-sectional side view of the first support member supporting a transportation roller, and FIG. 9B is a cross-sectional side view thereof taken at a position shifted from the position of the cross-section shown in FIG. 9A in a shaft line direction of the transportation roller.

FIG. 10 is a cross-sectional view taken along an X-X line in FIG. 4.

FIG. 11A is a cross-sectional side view of the second support member supporting a transportation roller, and FIG. 11B is a cross-sectional side view thereof taken at a position shifted from the position of the cross section shown in FIG. 11A in the shaft line direction of the transportation roller.

FIG. 12 is a plan view illustrating a relationship between a transportation roller and a support member according to a second embodiment.

### DESCRIPTION OF EXEMPLARY EMBODIMENTS

Hereinafter, embodiments of the invention will be described with reference to the drawings. In the following embodiments, identical constituent elements are assigned the same reference numerals and explanations thereof are given only in the embodiment described first, and explanations of the stated constituent elements will be omitted in the subsequent embodiments.

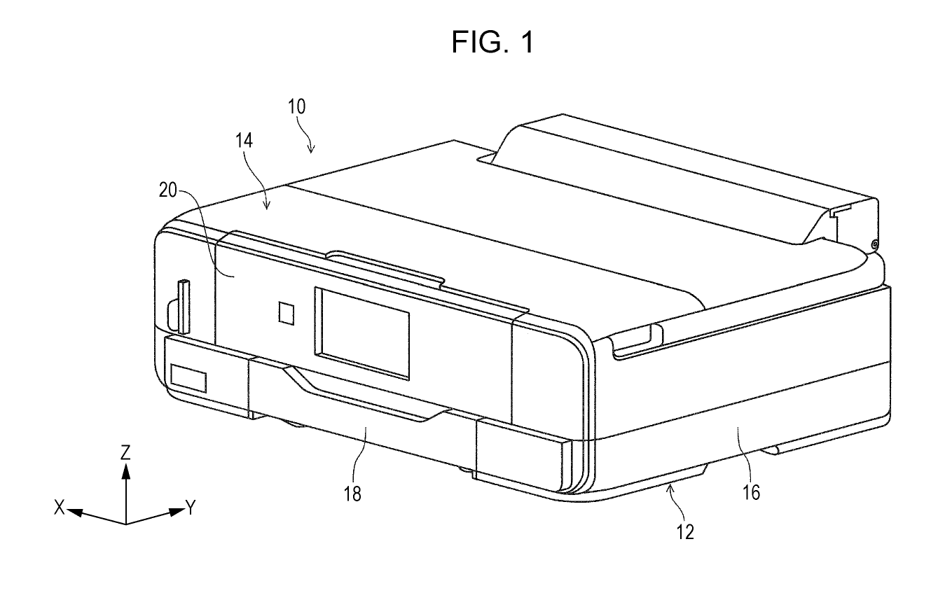

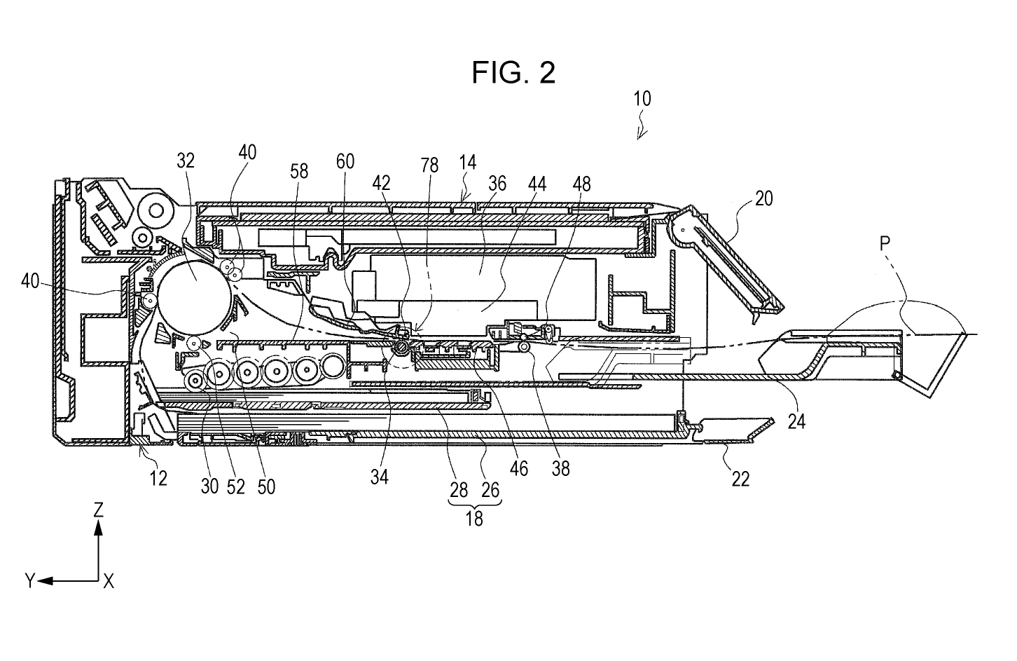

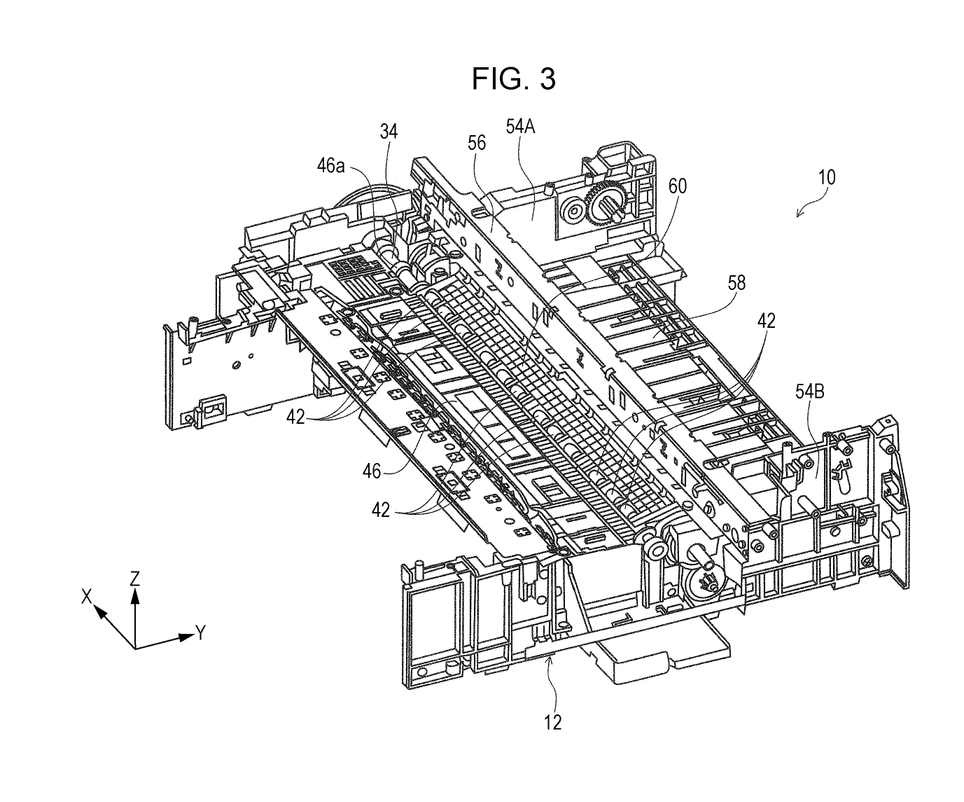

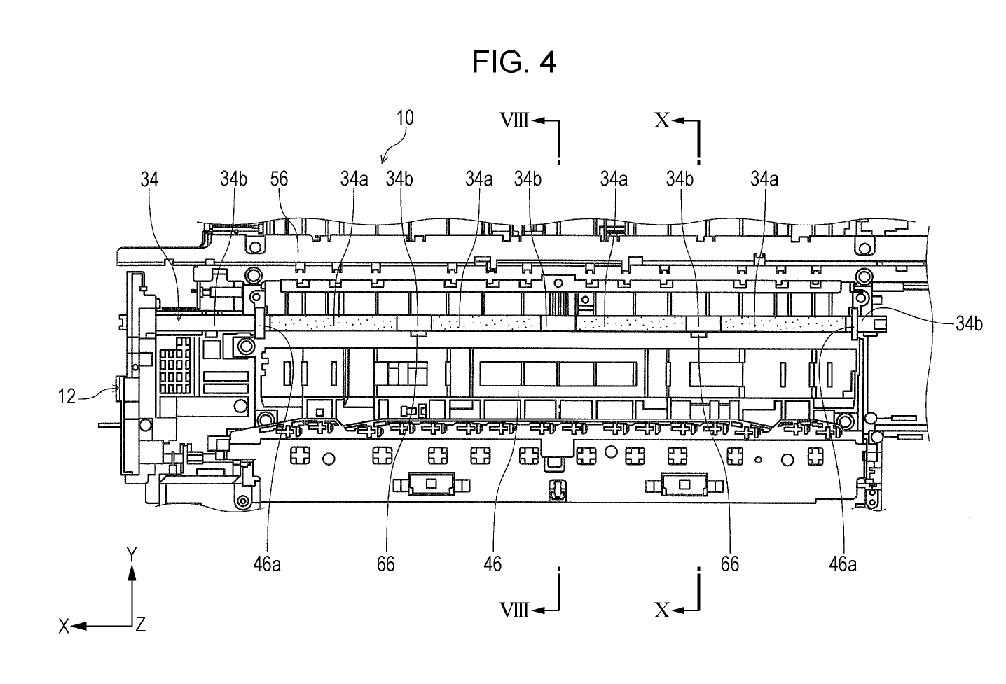

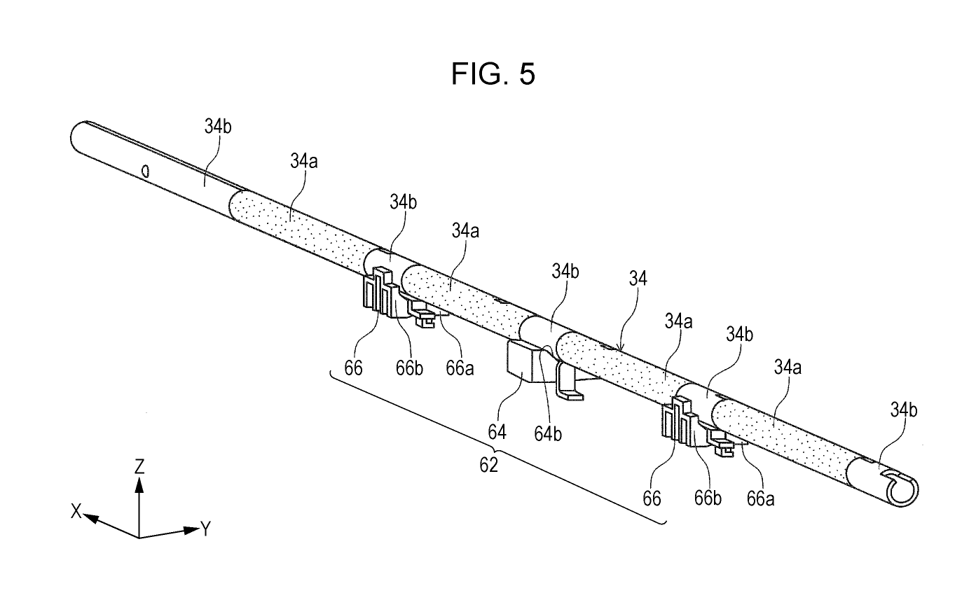

FIG. 1 is an exterior appearance perspective view of a printer according to the invention, FIG. 2 is a cross-sectional side view illustrating a paper transportation path of the printer according to the invention, FIG. 3 is a perspective view illustrating a frame of a printer according to a first embodiment, FIG. 4 is a plan view illustrating a relationship between a transportation roller and a support member according to the first embodiment, and FIG. 5 is a perspective view illustrating a relationship between the transportation roller and the support member according to the first embodiment.

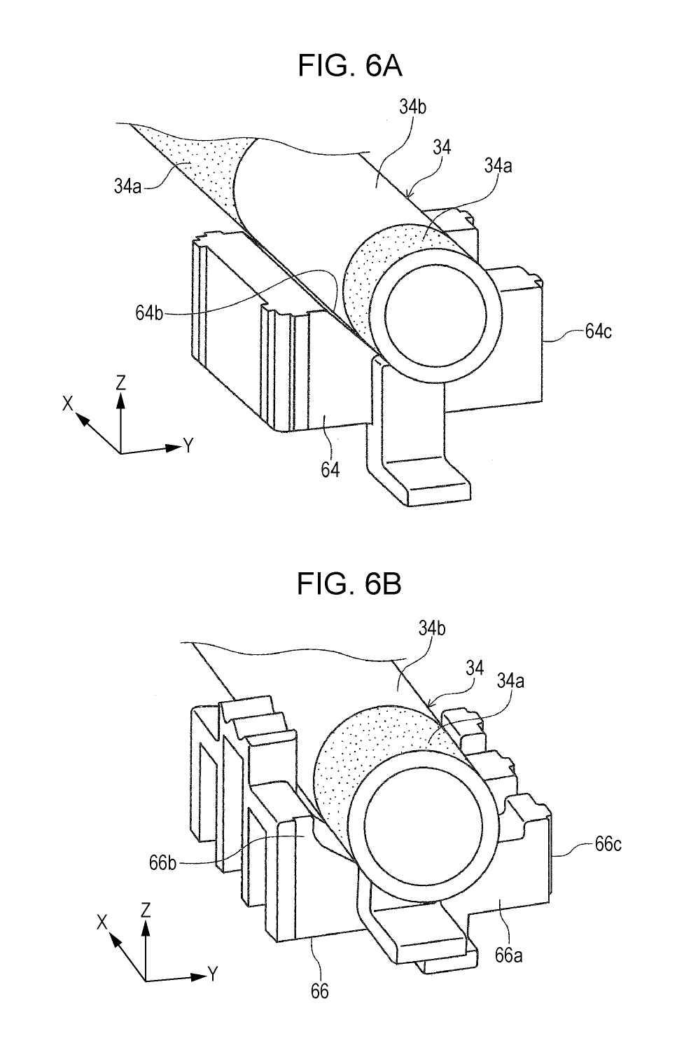

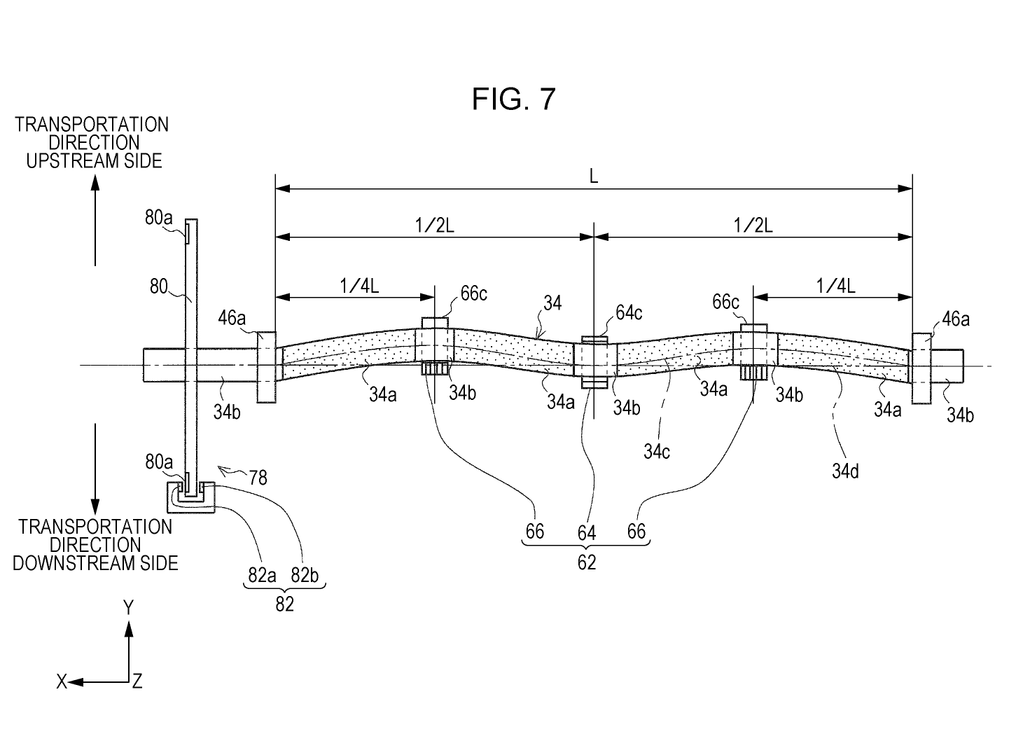

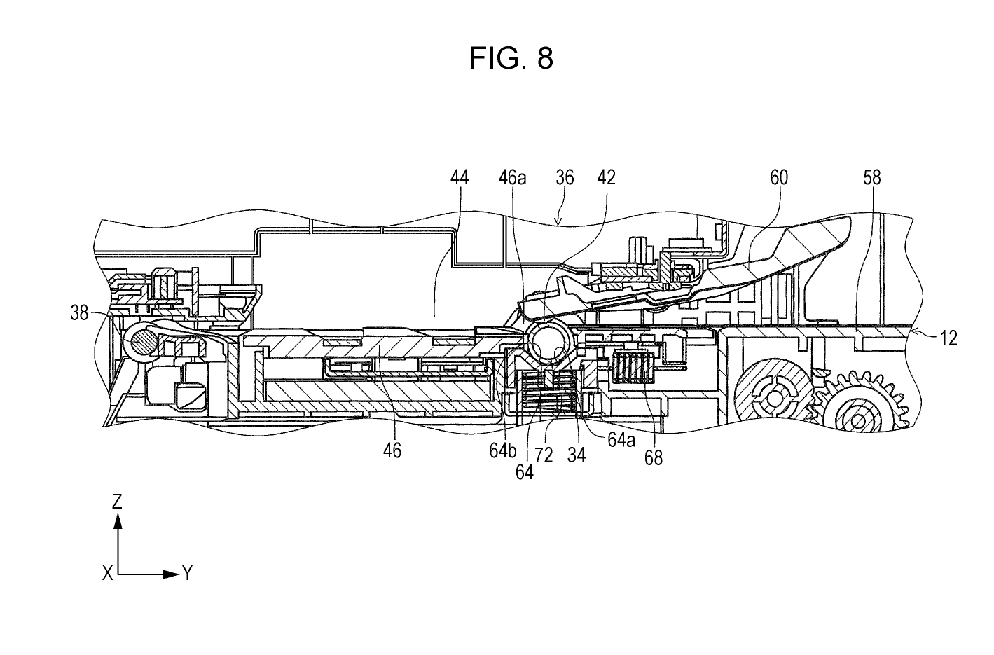

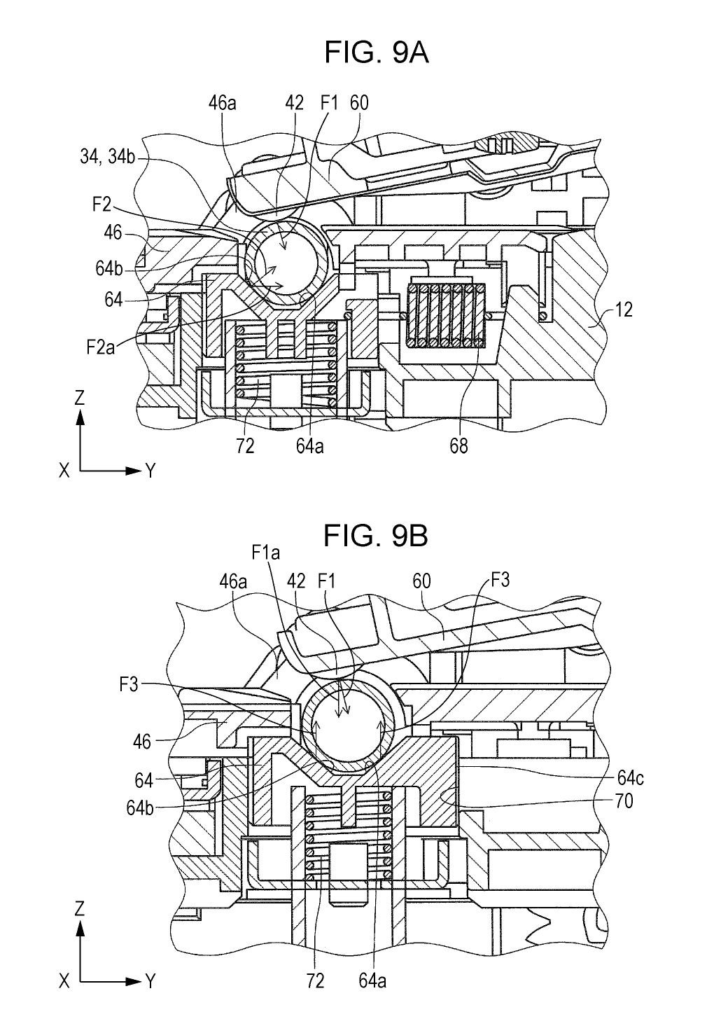

FIG. 6A is a perspective view illustrating a first support member supporting a center portion of the transportation roller, FIG. 6B is a perspective view illustrating a second support member supporting the transportation roller on both sides of the center portion of the transportation roller, FIG. 7 is a plan view illustrating a state of a transportation roller supported by bearings and the support members, FIG. 8 is a cross-sectional view taken along a VIII-VIII line in FIG. 4, FIG. 9A is a cross-sectional side view of the first support member supporting the transportation roller, and FIG. 9B is a cross-sectional side view thereof taken at a position shifted from the position of the cross section shown in FIG. 9A in a shaft line direction of the transportation roller.

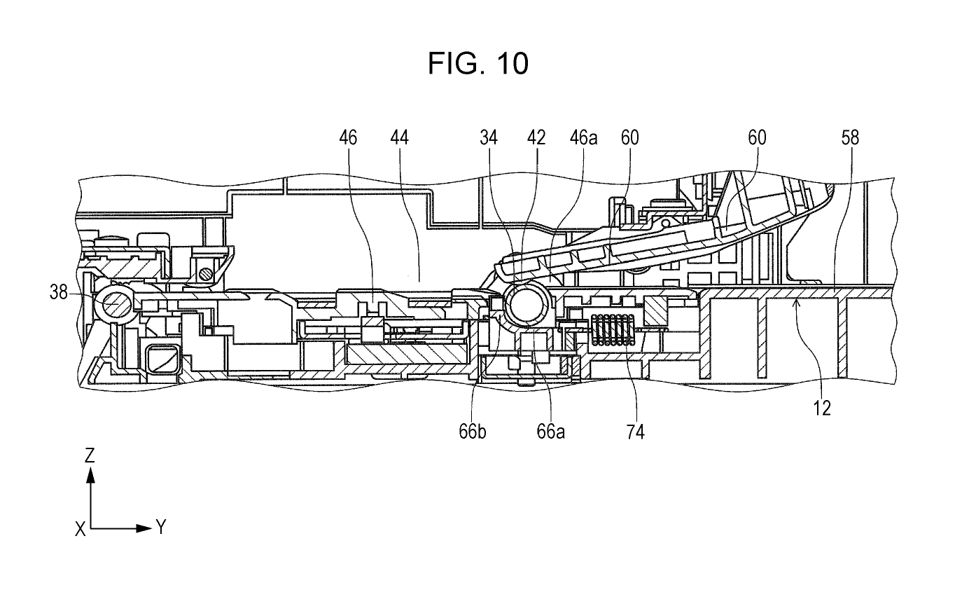

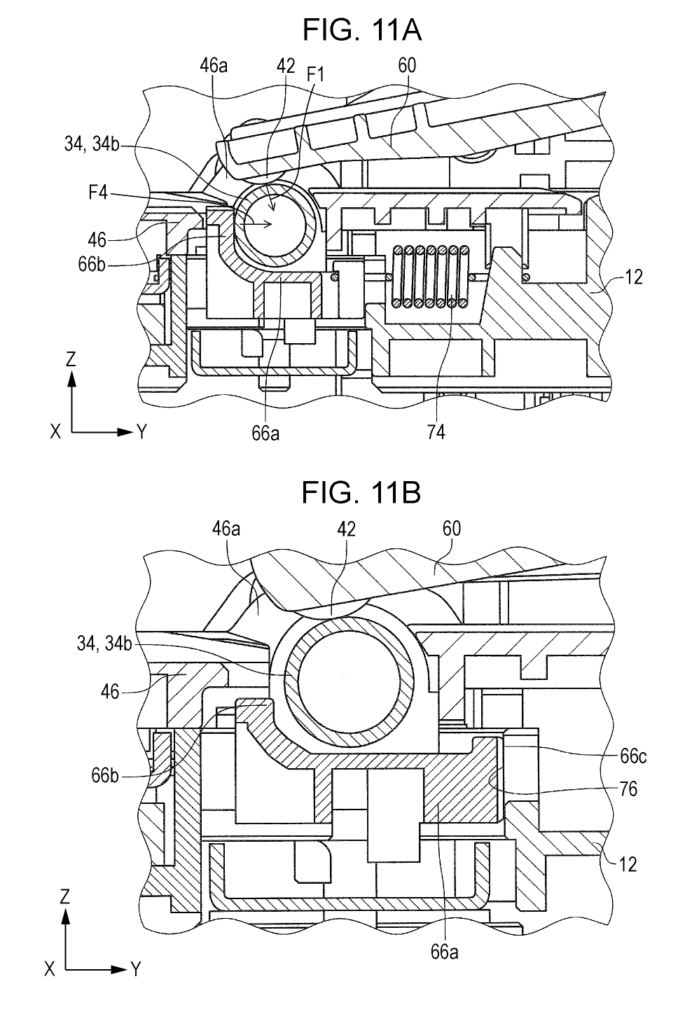

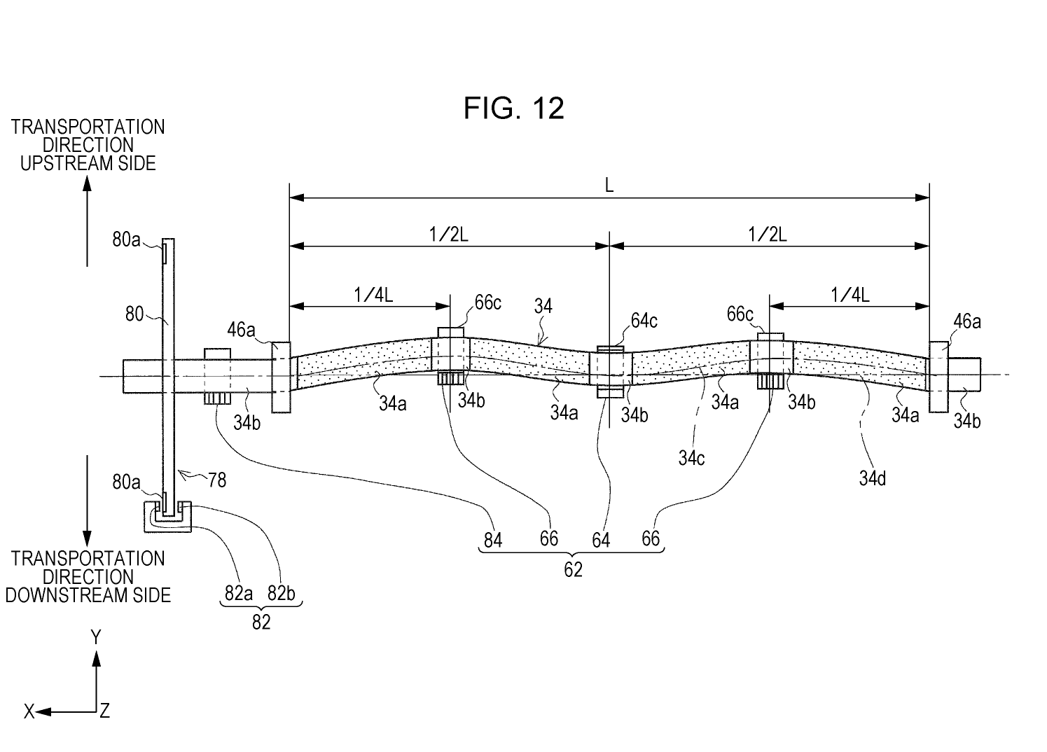

FIG. 10 is a cross-sectional side view taken along an X-X line in FIG. 4, FIG. 11A is a cross-sectional side view of the second support member supporting the transportation roller, FIG. 11B is a cross-sectional side view thereof taken at a position shifted from the position of the cross section shown in FIG. 11A in the shaft line direction of the transportation roller, and FIG. 12 is a plan view illustrating a relationship between a transportation roller and a support member according to a second embodiment.

In the X-Y-Z coordinate system indicated in each drawing, an X direction (apparatus width direction) represents a recording head scanning direction as well as a recording apparatus width direction, a Y direction represents a recording apparatus depth direction as well as a paper transportation direction, and a Z direction represents a direction in which a distance (gap) between the recording head and paper changes, that is, an apparatus height direction. Note that in each drawing, a −Y direction is taken as an apparatus front face side while a +Y direction is taken as an apparatus rear face side.

### Printer Overview

Referring to FIGS. 1 and 2, constituent elements of an ink jet printer 10 (hereinafter referred to as “printer 10”) will be described as an example of a recording apparatus. The printer 10 includes an apparatus main body 12 and an image reading device 14.

The apparatus main body 12 includes a housing 16 forming an exterior appearance of the apparatus, a medium accommodation unit 18 which is attachable/detachable to/from the apparatus main body 12 at a front face of the housing, and a panel unit 20 attached to the front face of the housing 16. As shown in FIG. 2, at the apparatus front face side of the medium accommodation unit 18 (−Y axis direction side in FIG. 2), there is attached a cover 22 rotatable relative to the medium accommodation unit 18 between a position where the cover 22 takes a closed posture (see FIG. 1) and a position where the cover 22 takes an opened posture (see FIG. 2). The image reading device 14 is provided on an upper portion of the apparatus main body 12 and is configured as what is called a scanner, which reads a medium being set on a setting surface thereof (not illustrated).

The panel unit 20 is provided with a power button, a print setting button, a display panel, and so on for operation of the printer 10, and is configured as an operation unit to operate the printer 10. The panel unit 20 is so configured as to be rotatable relative to the housing 16 toward the apparatus front side by a driving unit (not shown) (see FIG. 2). The driving unit is configured of, although not illustrated, a driving source and a mechanism including gears and the like for transmitting a driving force from the driving source to the panel unit 20.

### Paper Transportation Path

With reference to FIG. 2, a double-dot dash line, which is assigned a reference sign “P”, indicates a transportation path of paper P extending from the medium accommodation unit 18 to a discharge tray 24. The medium accommodation unit 18 is disposed at the uppermost stream side of the paper P transportation path. The medium accommodation unit 18 is so configured as to have a lower stage tray 26 for accommodating the paper P as a “target recording medium” and an upper stage tray 28 which is positioned above the lower stage tray 26 and accommodates the paper P.

The upper stage tray 28 is driven by a driving mechanism (not shown) toward the apparatus rear face side in the apparatus depth direction (+Y axis direction in FIG. 2), and is so configured as to be capable of moving between an end position, that is, a position where paper-feed can be carried out (see FIG. 2) and a retraction position (not shown) displaced by a predetermined amount from the above-mentioned end position toward the apparatus front face side in the apparatus depth direction. Note that paper P is an example of the target recording medium accommodated in the lower stage tray 26 and the upper stage tray 28. The paper P in this embodiment includes media having different paper sizes such as A4 size paper, B5 size paper, photographic printer paper, a postcard, and the like.

Further, in the apparatus main body 12, there are provided a pickup roller 30, a feed roller 32, a transportation roller 34, a carriage 36, and a discharge roller 38 along the paper transportation path. The pickup roller 30 is positioned above the trays 26 and 28, and is so configured as to be capable of swinging in a direction in which the pickup roller 30 makes contact with and leaves from paper P accommodated in the trays 26 and 28. The pickup roller 30 makes contact with, of the paper P accommodated in the lower stage tray 26 or the upper stage tray 28, the uppermost one and rotates, thereby feeding out the uppermost paper P from the lower stage tray 26 or the upper stage tray 28 to the paper transportation path.

The feed roller 32 is provided on the downstream side of the pickup roller 30 in the paper transportation path. A plurality of feed slave rollers 40 are provided on the circumference of the feed roller 32. The paper P fed out from the medium accommodation unit 18 by the pickup roller 30 is nipped between the feed roller 32 and the plurality of feed slave rollers 40 and is transported toward the paper transportation path downstream side.

On the paper transportation path downstream side of the feed roller 32, there are provided the transportation roller 34 as a “shaft member” that is driven by a driving motor (not shown), and a transportation slave roller 42 as a “roller” that is press-contacted to the transportation roller 34 and is driven to perform slave rotation. The paper P fed by the feed roller 32 is nipped between the transportation roller 34 and the transportation slave roller 42, and is transported toward the paper transportation path downstream side.

On the downstream side of the transportation roller 34, the carriage 36 is provided. A recording head 44 is provided on the bottom of the carriage 36. The recording head 44 discharges ink toward a recording surface of paper P to record on the paper P under the control of a control unit (not shown) provided within the apparatus main body 12. Under the carriage 36, a platen 46 to support the paper P is provided opposing the recording head 44. The carriage 36 is driven by a driving motor (not shown) so as to move back and forth in the apparatus width direction (X axis direction) in FIG. 2.

The platen 46 supports the paper P and defines a distance, or a gap between the platen 46 and the recording head 44. On the downstream side of the platen 46, there are provided the discharge roller 38 to feed out the paper P on which recording has been performed and a discharge slave roller 48 that makes contact with the discharge roller 38 and performs slave rotation. The discharge roller 38 is rotationally driven by a driving motor (not shown).

Paper P on which recording has been performed by the recording head 44 is nipped between the discharge roller 38 and the discharge slave roller 48 and is transported toward the downstream side of the transportation direction. Then, the paper P is discharged into the discharge tray 24 provided at the front face side of the apparatus main body 12 (−Y axis direction side in FIG. 1).

The discharge tray 24 is so configured by a discharge tray driving unit (not illustrated) as to be movable between a position at which the stated tray is accommodated in the apparatus main body 12 (see a double-dot dash line portion in FIG. 2) and a position to which the tray is projected from the apparatus main body 12 toward the front side of the apparatus depth direction (see a solid line portion in FIG. 2).

In the case where the printer 10 performs recording on both surfaces of the paper P, the recording head 44 records on a first surface of the paper P, and thereafter the paper P is returned to the upstream side of the transportation roller 34 by a reverse feed operation of the transportation roller 34 and the discharge roller 38 in a state in which the trailing edge of the paper when the first surface recording was performed is made to be the leading edge of the paper. Further, the paper P is fed to a reverse path 50 by a reversal operation of the transportation roller 34. The paper P having been fed into the reverse path 50 is nipped between the feed roller 32 and a reverse roller 52 and returned to the paper transportation path again.

The paper P having been returned to the paper transportation path is fed again to the transportation roller 34 on the paper transportation path downstream side by the feed roller 32. At this time, the first surface and a second surface of the paper P are curved and inverted so that the second surface thereof opposes the recording head 44. The paper P is fed by the transportation roller 34 to a position under the recording head 44 where the paper P opposes the recording head 44. The paper P, on the second surface of which recoding has been performed by the recording head 44, is discharged into the discharge tray 24 by the discharge roller 38.

### Control Unit

In this embodiment, within the apparatus main body 12, a control unit (not shown) is provided as an electric circuit configured of a plurality of electronic components. The control unit in this embodiment controls, in accordance with input commands from the panel unit 20, the image reading device 14, the medium accommodation unit 18, the driving unit of the panel unit 20 (not shown), the pickup roller 30, the feed roller 32, the transportation roller 34, the carriage 36, the discharge roller 38, the recording head 44, and the discharge tray driving unit (not shown); the control unit also controls operations necessary to carry out the recording and image reading of the printer 10 such as feeding of paper P in the case of using a detection unit 78 to be explained later, transporting, discharging, recording operation, and manuscript-reading operation, as well as the operations of the panel unit 20 and the discharge tray 24.

The control unit may control the operations necessary to carry out the recording and image reading of the printer 10 such as manuscript-reading operation and the like in accordance with commands from the exterior (from a PC, for example) instead of the input commands from the panel unit 20. Further, the control unit controls the movement of the carriage 36 in a scanning direction (X-axis direction in FIG. 2) and the ink discharge from the recording head 44.

### First Embodiment

With reference to FIGS. 3 through 7, a first embodiment will be described hereinafter. Referring to FIG. 3, a pair of side surface frames 54A and 54B configuring part of the apparatus main body 12 is provided within the apparatus main body 12. The side surface frames 54A and 54B are disposed opposing each other with an interval therebetween in a direction intersecting with the paper transportation direction, in other words, in a width direction of the printer 10. Further, between the side surface frame 54A and the side surface frame 54B in the width direction of the printer 10, there are disposed the platen 46, a guide frame 56 to guide the movement of the carriage 36 in the apparatus width direction, and a reinforcement frame 58 so as to connect the side surface frames 54A and 54B.

Referring to FIGS. 3 and 4, the transportation roller 34 extending in the apparatus width direction is disposed between the guide frame 56 and the platen 46 in the paper P transportation direction. Further, in this embodiment, the plurality of transportation slave rollers 42 are disposed on the upper side of the transportation roller 34 in the apparatus height direction along a direction in which the transportation roller 34 extends. A paper pushing member 60 (see FIGS. 2 and 3) is attached to the guide frame 56 in a rotatable manner relative to the guide frame 56. The plurality of transportation slave rollers 42 are attached in a rotatable manner to an end portion of the paper pushing member 60 on the downstream side of the paper transportation direction.

Although not illustrated in this embodiment, a bias member is provided between the guide frame 56 and the paper pushing member 60. A bias force of the stated bias member acts in a direction in which the transportation slave roller 42 is biased toward the transportation roller 34, which causes the transportation slave roller 42 to make contact with and press the transportation roller 34. The transportation slave roller 42 of this embodiment is formed with, for example, a thermoplastic resin such as polyoxymethylene (POM) or the like.

Referring to FIG. 4, a pair of bearings 46a and 46a is provided at an end portion of the platen 46 on the upstream side of the transportation direction. Of the pair of bearings 46a and 46a, one bearing 46a is, at the end portion of the platen 46 on the upstream side of the transportation direction, provided at an end portion on the −X axis direction side of the apparatus width direction, while the other bearing 46a is, at the end portion of the platen 46 on the upstream side of the transportation direction, provided at an end portion on the +X axis direction side of the apparatus width direction. In this embodiment, the pair of bearings 46a and 46a is so configured as to pivotally support both end portions of the transportation roller 34.

Referring to FIG. 5, the transportation roller 34 extending in the apparatus width direction in this embodiment is configured as a hollow shaft member. In the embodiment, the transportation roller 34 has high friction portions 34a (areas indicated by multiple black dots in FIG. 5, FIG. 6A, and FIG. 6B) and low friction portions 34b on a circumferential surface of the transportation roller 34. The high friction portion 34a is formed by applying abrasion resistant particles such as ceramics on the circumferential surface of the transportation roller 34 using a coating material, for example. The coating material sticks and holds the high abrasion resistant particles on the above-mentioned circumferential surface. Note that in this embodiment, the high friction portions 34a make contact with paper P and transport the paper P with a frictional force generated between the high friction portions 34a and the surface of the paper P.

In this embodiment, the low friction portions 34b are so configured as to have a lower friction coefficient than the high friction portions 34a. For example, by performing abrasive finishing on the low friction portions 34b of the transportation roller 34, surface roughness of the low friction portions 34b is reduced so that the friction coefficient thereof can be made smaller.

In this embodiment, the low friction portions 34b and 34b provided at both the end portions of the transportation roller 34 are pivotally supported by the bearings 46a and 46a provided on the platen 46, as shown in FIG. 4. This makes it possible to suppress a frictional force generated between the transportation roller 34 and the bearing 46a during the transportation roller 34 rotating.

In this embodiment, as shown in FIG. 5, the plurality of low friction portions 34b are provided in the transportation roller 34 between the bearings 46a and 46a. A plurality of pressing members 62 as “defining members” are in contact with these low friction portions 34b.

As shown in FIG. 7, the basic concept of this embodiment is such that the plurality of pressing members 62 disposed at appropriate intervals along the shaft line direction of the transportation roller 34 press a section of the transportation roller 34 between the bearings 46a and 46a, and the transportation roller 34 is rotationally driven in a state in which the above-mentioned section is deformed being arched toward the upstream side of the paper P transportation direction. As shown in FIG. 7, this embodiment is so configured as to have a state in which portions between the pressing member 62 that is disposed approximately at the center portion of the transportation roller 34 between the bearings 46a, 46a (a first pressing member 64 to be explained later) and the bearings 46a, 46a are each deformed being arched, in other words, there are provided two portions that are deformed being arched between the bearings 46a and 46a.

Note that in FIG. 7, the deformed state of the transportation roller 34 is illustrated in an exaggerated manner compared to the actual deformed state for the sake of explanation. A dot-dash line, assigned a reference numeral 34c, indicates the shaft line of the transportation roller 34 in the deformed state, while a double-dot dash line, assigned a reference numeral 34d, indicates the shaft line of the transportation roller 34 in a state prior to the transportation roller 34 being deformed. In this embodiment, the most deformed part in the arched portion of the transportation roller 34 is bent toward the upstream side of the transportation direction by approximately 0.2 mm, for example, compared to the state of the roller before being deformed.

By rotationally driving the transportation roller 34 in a state of being deformed in an arched shape in the transportation direction, a rotational swing of the transportation roller 34 generated during the rotation thereof, particularly a rotational swing in the transportation direction can be suppressed or corrected with the plurality of pressing members 62. As a result, since the rotational swing of the transportation roller 34 during the rotation thereof can be made smaller, the transportation precision of paper P can be maintained and the recording quality of the paper P can be maintained as well.

To be more specific, in this embodiment, the plurality of pressing members 62 include the first pressing member 64 and the second pressing members 66. As shown in FIGS. 5 and 7, the first pressing member 64 and second pressing members 66 make contact with the low friction portions 34b of the transportation roller 34.

In this embodiment, as an example of the configuration, the first pressing member 64 is disposed approximately at the center of a section of the transportation roller 34 between the bearings 46a and 46a. The second pressing members 66 are disposed on both sides of the first pressing member 64 in the shaft line direction of the transportation roller 34. More specifically, the second pressing members 66 are each provided at a position distanced from the position where the transportation roller 34 is pivotally supported by the bearing 46a by one fourth the total length of the section of the transportation roller 34 between the bearings 46a and 46a toward the first pressing member 64 side.

Further, in this embodiment, as shown in FIG. 7, the first pressing member 64 and the second pressing members 66 press the transportation roller 34 so that a rotational center position of the transportation roller 34 at the pressurized section is shifted toward the upstream side of the paper P transportation direction relative to a rotational center position of the transportation roller 34 at the section of the bearing 46a. In this embodiment, the section of the transportation roller 34 pressed by the second pressing member 66 is bent by approximately 0.2 mm, for example, toward the upstream side of the transportation direction relative to the section pivotally supported by the bearing 46a.

Furthermore, referring to FIG. 7, the detection unit 78 for detecting the rotation of the transportation roller 34 is provided at one end portion of the transportation roller 34 (+X axis direction side in FIG. 7). The detection unit 78 will be described later.

### Pressing Member

With reference to FIG. 6A, FIG. 6B, and FIGS. 8 through 11B, the configuration of the pressing members 62, that is, the first pressing member 64 and the second pressing members 66 will be hereinafter described. The configuration of the first pressing member 64 will be described first. Note that the pressing member 62 of this embodiment is formed with, for example, a thermoplastic resin such as polyoxymethylene (POM) or the like, or more preferably formed with a material exhibiting excellence in sliding characteristics among the resin materials.

### First Pressing Member

As shown in FIG. 8, the first pressing member 64 is disposed on the upstream side of the recording head 44 and the platen 46 opposing the recording head 44 in the paper P transportation path and is also disposed approximately at the center of the section of the transportation roller 34 between the bearings 46a and 46a, and supports the transportation roller 34. In this state, the transportation roller 34 is biased with a bias force F1 (see FIG. 9A) applied by the transportation slave roller 42 attached to the paper pushing member 60. In this embodiment, a single first pressing member 64 is provided in the shaft line direction of the transportation roller 34. FIG. 8 illustrates a cross section taken along the VIII-VIII line in FIG. 4.

Referring to FIGS. 9A and 9B, the first pressing member 64 includes a first slope 64a extending toward the upstream side of the paper P transportation direction and also extending toward the upper side of the apparatus height direction, and a second slope 64b extending toward the downstream side of the paper P transportation direction and also extending toward the upper side of the apparatus height direction. In this embodiment, the first slope 64a and the second slope 64b configure a V-shape reception portion for receiving part of the transportation roller 34 on the upper portion of the first pressing member 64.

Further, as shown in FIG. 9A, within the apparatus main body 12, there is provided a first bias unit 68 as a “bias unit” on the upstream side of the transportation direction relative to the first pressing member 64. In this embodiment, the first bias unit 68 is configured as a tension spring. One end portion of the first bias unit 68 is connected to the apparatus main body 12, while the other end portion thereof is connected to an end portion of the first pressing member 64 on the upstream side of the transportation direction. The first bias unit 68 biases the first pressing member 64 toward the upstream side of the transportation direction.

FIG. 9B illustrates a cross section taken at a position shifted in the shaft line direction of the transportation roller 34 compared to FIG. 9A. As shown in FIG. 9B, in the case where the first pressing member 64 is biased by the first bias unit 68 toward the upstream side of the transportation direction, an end portion 64c of the first pressing member 64 on the upstream side of the transportation direction makes contact with a contact portion 70 provided in the apparatus main body 12. The contact portion 70 in this embodiment regulates the position of the first pressing member 64 in the transportation direction. In this embodiment, the position of the contact portion 70 in the paper P transportation direction is set such that the rotational center position of a section of the transportation roller 34 supported by the first pressing member 64 substantially matches the rotational center position of a section pivotally supported by the bearing 46a in the paper P transportation direction in a state where the end portion 64c of the first pressing member 64 is in contact with the contact portion 70.

Then, a bias force F2 of the first bias unit 68 acts so as to bias the transportation roller 34 in a direction perpendicular to the second slope 64b. Here, in the case where a component of the bias force F2 in the paper transportation direction is taken as F2a, the second slope 64b biases the transportation roller 34 toward the upstream side of the transportation direction with the bias force F2a. In this embodiment, the magnitude of the bias force F2a of the first bias unit 68 is so set as to maintain the state in which the first pressing member 64 is in contact with the contact portion 70.

In addition, a second bias unit 72 is provided under the first pressing member 64 in the apparatus height direction. The second bias unit 72 is configured as a coil spring in this embodiment. Then, one end portion of the second bias unit 72 is connected to the apparatus main body 12 and the other end portion thereof is connected to the bottom of the first pressing member 64. In other words, the second bias unit 72 biases the first pressing member 64 toward the upper side of the apparatus height direction.

Specifically, a bias force F3 of the second bias unit 72 biases the transportation roller 34 toward the upper side of the apparatus height direction via the first slope 64a and the second slope 64b of first pressing member 64. In this embodiment, the second pressing member 66 is not biased toward the upper side of the apparatus height direction, which will be explained later in detail. In this embodiment, the bias force F3 of the second bias unit 72 is so set as to be balanced with a vertical direction component F1a of the bias force F1 of the transportation slave roller 42, shown in FIG. 9B, which is applied to the transportation roller 34.

In the case where the bias force F1a is greater than the bias force F3, the transportation roller 34 is pushed down toward the lower side of the apparatus height direction by the transportation slave roller 42 biasing the transportation roller 34. As a result, there arises a risk in which the leading edge of paper P nipped between the transportation roller 34 and the transportation slave roller 42 and transported toward the downstream side of the transportation direction makes contact with an end portion of the platen 46 on the upstream side of the transportation direction, which may raise a risk of paper clogging (paper jam).

On the other hand, in the case where the bias force F3 is greater than the bias force F1a, the transportation roller 34 is displaced toward the upper side of the apparatus height direction while resisting the transportation slave roller 42 biasing the transportation roller 34. As a result, the nipping position in the apparatus height direction between the transportation roller 34 and the transportation slave roller 42 becomes higher than the nipping position in a state where the bias force F3 and the bias force F1a are balanced with each other. This raises a risk that the leading edge of paper P nipped between the transportation roller 34 and the transportation slave roller 42 and transported toward the downstream side of the transportation direction makes contact with a nozzle surface of the recording head 44, which may deteriorate the recording quality of the paper P.

Since the bias force F3 and the bias force F1a are so set as to be balanced with each other in this embodiment, the nipping position in the apparatus height direction between the transportation roller 34 and the transportation slave roller 42 can be set to a position capable of suppressing the occurrence of the above-mentioned problem during the transportation of paper P. In other words, since the leading edge of paper P can be appropriately fed into between the recording head 44 and the platen 46, a distance between the paper P fed onto the platen 46 and the recording head 44 can be maintained to be constant.

### Second Pressing Member

The second pressing member 66 will be described next. In this embodiment, two second pressing members 66 are provided along the shaft line direction of the transportation roller 34 (see FIG. 5). As shown in FIG. 10, the second pressing members 66 are each provided at a position on the transportation direction upstream side of the recording head 44 and the platen 46 opposing the recording head 44 in the paper P transportation path. Further, the second pressing members 66 are each provided at a position distanced from the position where the transportation roller 34 is pivotally supported by the bearings 46a and 46a, which are positioned on both the end portions of the transportation roller 34, by one fourth the total length of the section of the transportation roller 34 between the bearings 46a and 46a toward the first pressing member 64 side in the shaft line direction of the transportation roller 34. FIG. 10 illustrates a cross section taken along the X-X line in FIG. 4.

As shown in FIG. 11A, the second pressing member 66 includes a base portion 66a extending along the paper P transportation direction and a bias portion 66b projecting toward the upper side of the apparatus height direction at an end portion of the base portion 66a on the downstream side of the transportation direction.

Further, as shown in FIG. 11A, within the apparatus main body 12, there is provided a third bias unit 74 as a “bias unit” on the upstream side of the transportation direction relative to the second pressing member 66. The third bias unit 74 is configured as a tension spring in this embodiment. One end portion of the third bias unit 74 is connected to the apparatus main body 12 and the other end portion thereof is connected to an end portion of the second pressing member 66 on the upstream side of the transportation direction. The third bias unit 74 biases the second pressing member 66 toward the upstream side of the transportation direction.

Here, FIG. 11B illustrates a cross section taken at a position shifted in the shaft line direction of the transportation roller 34 compared to FIG. 11A. As shown in FIG. 11B, in the case where the second pressing member 66 is biased by the third bias unit 74 toward the upstream side of the transportation direction, an end portion 66c of the base portion 66a of the second pressing member 66 on the upstream side of the transportation direction makes contact with a contact portion 76 provided in the apparatus main body 12. The contact portion 76 in this embodiment regulates the position of the second pressing member 66 in the transportation direction. In this embodiment, the position of the contact portion 76 in the paper P transportation direction is set such that the rotational center position of the section of the transportation roller 34 pressed by the second pressing member 66 is shifted on the upstream side of the paper P transportation direction by substantially 0.2 mm relative to the rotational center position of the section pivotally supported by the bearing 46a in a state where the end portion 66c of the second pressing member 66 is in contact with the contact portion 76. That is, the position of the contact portion 76 in the transportation direction is shifted by substantially 0.2 mm toward the upstream side of the transportation direction relative to the position of the contact portion 70.

Then, a bias force F4 of the third bias unit 74 biases the transportation roller 34 toward the upstream side of the transportation direction via the bias portion 66b. In this embodiment, the magnitude of the bias force F4 of the third bias unit 74 is so set as to maintain the state in which the second pressing member 66 is in contact with the contact portion 76.

In summary, the plurality of pressing members 62 are provided at appropriate intervals in the shaft line direction of the transportation roller 34, and the shape of the transportation roller 34 is so regulated as to be in a deformed state being arched toward the upstream side of the transportation direction between the bearings 46a and 46a or the state having been deformed in an arched shape in advance is maintained. Because of this, in the case where the transportation roller 34 is rotated, a rotational swing generated in the transportation roller 34, particularly a rotational swing in the transportation direction can be suppressed or corrected with the plurality of pressing members 62.

Further, because the plurality of pressing members 62 are provided at appropriate intervals along the shaft line direction of the transportation roller 34, even if the peak of the rotational swing of the transportation roller 34 may be present at any position in the shaft line direction of the transportation roller 34, the peak of the rotational swing can be lowered or corrected with the plurality of pressing members 62. As a result, since the rotational swing of the transportation roller 34 during rotation thereof can be made smaller, the transportation precision of paper P can be maintained and the recording quality of the paper P can be maintained as well.

According to this embodiment, because the plurality of pressing members 62 are provided at appropriate intervals in the shaft line direction of the transportation roller 34 and press the transportation roller 34 to shift the rotational center position of the transportation roller 34 at the pressurized sections toward the upstream side of the transportation direction relative to the rotational center position thereof at the sections of the bearings 46a and 46a, in the case where the transportation roller 34 is rotated, a rotational swing generated in the transportation roller 34, particularly a rotational swing in the transportation direction can be suppressed or corrected with the plurality of pressing members 62. As a result, since the rotational swing of the transportation roller 34 during rotation thereof can be made smaller, the transportation precision of the paper P can be maintained and the recording quality of the paper P can be maintained as well.

In this embodiment, the first pressing member 64 presses the transportation roller 34 toward the upstream side of the transportation direction and also presses the transportation roller 34 in a direction resisting the vertical direction component F1a of the load F1 that is applied from the transportation slave roller 42; the second pressing members 66 press the transportation roller 34 toward the upstream side of the transportation direction. That is, only the first pressing member 64 presses the transportation roller 34 in a direction resisting the load F1a. In this embodiment, the vertical direction component F1a of the load F1 of the transportation slave roller 42 that acts on the transportation roller 34 and the pressing force F3 with which the first pressing member 64 presses the transportation roller 34 are so set as to be balanced with each other in the direction resisting the load. As a result, because the load F1a applied from the transportation slave roller 42 and the pressing force F3 from the first pressing member 64 are balanced with each other in the transportation roller 34, the nipping position between the transportation roller 34 and the transportation slave roller 42 can be maintained to be constant in the direction resisting the vertical direction component F1a of the load F1. This makes it possible to maintain a distance from the recording head 44 to the paper P to be constant in the direction resisting the load F1a, and maintain the recording quality of the paper P.

In this embodiment, because the first bias unit 68 and the third bias unit 74 maintain a state in which the first pressing member 64 and the second pressing members 66 make contact with the contact portions 70 and 76, respectively, the rotational swing of the transportation roller 34 can be more surely suppressed, the decrease in the paper P transportation precision in the transportation direction can be suppressed, and the recording quality of the paper P can be maintained.

In this embodiment, the transportation roller 34 includes, in the shaft line direction thereof, the high friction portions 34a that make contact with paper P and transport the paper P with a frictional force generated between the paper P and the high friction portions 34a, and the low friction portions 34b having a lower friction coefficient than the high friction portions 34a and making contact with the pressing members 62; and the pressing members 62 press the low friction portions 34b. As such, in the case where the transportation roller 34 is rotated, sliding resistance between the low friction portions 34b of the transportation roller 34 and the pressing members 62 can be reduced, the transportation roller 34 can be smoothly rotated, and the paper P can be smoothly transported by the transportation roller 34. As a result, a variation in transportation precision of the paper P in the transportation direction can be suppressed, and the recording quality of the paper P can be maintained.

### Variation on First Embodiment

1. In this embodiment, the transportation roller 34 is so configured as to be deformed being arched toward the upstream side of the transportation direction between the bearings 46a and 46a. However, in place of this configuration, such a configuration may be employed that the transportation roller 34 is deformed being arched toward the downstream side of the transportation direction between the bearings 46a and 46a.

2. In this embodiment, the second pressing members 66 are configured so as not to include the second bias unit 72 for biasing toward the upper side of the apparatus height direction. However, in place of this configuration, such a configuration may be employed that bias units for biasing the second pressing members 66 toward the upper side of the apparatus height direction are included therein. Note that in the stated configuration, it is necessary to set the total force of the bias force F3 of the second bias unit 72 biasing the first pressing member 64 toward the upper side of the apparatus height direction and the bias force of the above-mentioned bias unit biasing the second pressing member 66 toward the upper side of the apparatus height direction so that the stated total force and the vertical direction component F1a of the bias force F1 of the transportation slave roller 42 are balanced with each other.

3. The configuration in which a section of the transportation roller 34 between the bearings 46a and 46a is pressed by a single first pressing member 64 along with two second pressing members 66 to be deformed in an arched shape is employed in this embodiment. However, in place of this configuration, such a configuration may be employed that at least one or more first pressing members 64 are disposed, at least one or more second pressing members 66 are disposed, or at least one or more first pressing members 64 as well as at least one or more second pressing members 66 are disposed in a section of the transportation roller 34 between the bearings 46a and 46a. In other words, the configuration may be such that a section of the transportation roller 34 between the bearings 46a and 46a is pressed by at least one pressing member 62 to be deformed in an arched shape.

4. In this embodiment, the position of the contact portion 70 in the paper P transportation direction is set such that the rotational center position of a portion of the transportation roller 34 supported by the first pressing member 64 substantially matches the rotational center position of a portion of the transportation roller 34 pivotally supported by the bearing 46a in a state where the end portion 64c of the first pressing member 64 is in contact with the contact portion 70. However, in place of this configuration, such a configuration may be employed that the position of the contact portion 70 in the transportation direction is shifted toward the upstream or downstream side of the transportation direction relative to the bearing 46a.

5. In this embodiment, the configuration in which there are provided two portions where the transportation roller 34 is deformed in an arched shape between the bearings 46a and 46a is employed. However, in place of this configuration, such a configuration may be employed that one or no less than three portions where the transportation roller 34 is deformed in an arched shape between the bearings 46a and 46a are provided.

6. In this embodiment, the first pressing member 64 is disposed approximately at the center of the transportation roller 34 in the shaft line direction thereof between the bearings 46a and 46a, and the second pressing members 66 and 66 are each disposed at a position distanced from the bearing 46a by one fourth the total length of a section of the transportation roller 34 between the bearings 46a and 46a toward the first pressing member 64. However, in place of this configuration, such a configuration may be employed that the plurality of pressing members 62 are provided corresponding to positions where the rotational swing of the transportation roller 34 becomes large in the shaft line direction thereof during the transportation roller 34 rotating so as to press the transportation roller 34 toward the upstream side of the transportation direction. To be more specific, the magnitude of the rotational swing in the section of the transportation roller 34 between the bearings 46a and 46a may be measured, and based on the measurement result, the pressing members 62 may be disposed at the positions where the rotational swing is large so as to press those positions.

With this configuration, in the case where the transportation roller 34 is rotated, a rotational swing generated in the transportation roller 34, particularly a rotational swing in the transportation direction can be suppressed or corrected with the plurality of pressing members 62. As a result, since the rotational swing of the transportation roller 34 during the rotation thereof can be made smaller, the transportation precision of paper P can be maintained and the recording quality of the paper P can be maintained as well.

### Second Embodiment

With reference to FIG. 12, a second embodiment will be described. The second embodiment is different from the first embodiment in a point that the pressing member 62 is provided between the bearing 46a and the detection unit 78. The overview of the detection unit 78 is described first, and then this embodiment will be described in detail. Note that in FIG. 12, a deformed state of the transportation roller 34 is illustrated in an exaggerated manner compared to the actual deformed state for the sake of explanation. Further, a dot-dash line, assigned the reference numeral 34c, indicates the shaft line of the transportation roller 34 in the deformed state, while a double-dot dash line, assigned the reference numeral 34d, indicates the shaft line of the transportation roller 34 in the state prior to the transportation roller 34 being deformed.

### Detection Unit

Referring to FIG. 12, the detection unit 78 for detecting a rotational state of the transportation roller 34 is provided at one end portion of the transportation roller (an end portion on the +X axis direction side in FIG. 12). In this embodiment, the detection unit 78 is configured as a rotary encoder, for example. More specifically, the detection unit 78 includes a rotary scale 80 and an optical sensor 82.

The rotary scale 80 of this embodiment is made of a transparent material and formed in a disk-like shape. The disk-like rotary scale 80 is so attached to the one end portion of the transportation roller 34 as to rotate with the rotation of the transportation roller 34.

As an exemplified configuration of this embodiment, the rotary scale 80 is made of a polyethylene terephthalate resin (PET). On one disk surface of the rotary scale 80, a ring-shaped position detection pattern 80a is provided. In the ring-shaped position detection pattern 80a, a plurality of transparent portions that allow light to pass and a plurality of light-blocking portions that do not allow light to pass are alternately formed. In this embodiment, the transparent portions and the light-blocking portions are formed with the same width dimension, in other words, formed with the same pitch.

The optical sensor 82 is provided in the apparatus main body 12. The optical sensor 82 includes a radiating portion 82a and a light-receiving portion 82b; the radiating portion 82a and the light-receiving portion 82b are provided opposing each other with an interval therebetween. In this embodiment, the radiating portion 82a is formed as a light-emitting portion configured to emit light using a light source such as a light-emitting element or the like, while the light-receiving portion 82b includes a light-receiving element such as a phototransistor, photodiode, or the like capable of converting received light to an electric signal in proportion to the amount of received light.

In this embodiment, when light is radiated from the radiating portion 82a in the optical sensor 82, that light is received by the light-receiving portion 82b positioned on a light radiating direction side. This makes the optical sensor 82 be in a detection mode. Meanwhile, in a state in which light from the radiating portion 82a is blocked and the light receiving portion 82b cannot receive the light, the optical sensor 82 is in a non-detection mode.

In this embodiment, the rotary scale 80 is disposed such that at least part of the rotary scale 80 is positioned in a gap between the radiating portion 82a and the light-receiving portion 82b. More specifically, the position detection pattern 80a of the rotary scale 80 is positioned between the radiating portion 82a and the light-receiving portion 82b. In other words, when the transportation roller 34 is rotationally driven, the rotary scale 80 is also rotationally driven in the same rotational direction as that of the transportation roller 34 so that the transparent portions and the light-blocking portions of the position detection pattern 80a alternately traverse an optical axis of the light radiated from the radiating portion 82a between the radiating portion 82a and the light-receiving portion 82b of the optical sensor 82.

Accordingly, in the case where the transparent portion is positioned in the optical axis, the light from the radiating portion 82a passes the transparent portion and is received by the light-receiving portion 82b, thereby leading to the detection mode. Meanwhile, in the case where the light-blocking portion is positioned in the optical axis, the light from the radiating portion 82a is blocked and is not received by the light-receiving portion 82b, thereby leading to the non-detection mode.

In the case where light is detected by the light-receiving portion 82b of the optical sensor 82, the light is converted to an electric signal by the aforementioned light-receiving element, and the stated electric signal is received as a detection signal by the control unit (not shown) provided within the apparatus main body 12. The control unit controls the number of rotations and rotational speed of the transportation roller 34 via a driving motor (not shown) or the like based on the above-mentioned detection signal. Through this, the control unit performs position control and transportation speed control on paper P in the transportation path; note that the paper P is transported along the paper transportation path.

### Explanation of Embodiment

Referring to FIG. 12, the arrangement of the first pressing member 64 and the second pressing members 66 on the transportation roller 34 between the bearings 46a and 46a is the same as that of the first embodiment. In this embodiment, the pressing member 62 is disposed on the transportation roller 34 at a position between the detection unit 78 and the bearing 46a on the side where the detection unit 78 is provided. To be more specific, a third pressing member 84 is disposed.

The third pressing member 84 of this embodiment has the same configuration as the second pressing member 66, for example, and presses a section of the transportation roller 34 between the bearing 46a and the detection unit 78 toward the upstream side of the transportation direction.

In the case where an end portion of the transportation roller 34 is not pressed by the third pressing member 84, due to a rotational swing at the end portion of the transportation roller 34, the rotary scale 80 will be in a state in which the rotary scale 80 rotates and vibrates about the transportation roller 34. Then, in the gap between the radiating portion 82a and the light-receiving portion 82b of the optical sensor 82, the position detection pattern 80a of the rotary scale 80 varies in position toward the upstream and downstream sides of the transportation direction along with the rotation of the transportation roller 34. As a result, there arises a risk in which the detection precision of the position detection pattern 80a is decreased in the optical sensor 82, which raises a risk that the rotational state of the transportation roller 34 cannot be correctly detected.

In this embodiment, because the third pressing member 84 presses a section of the transportation roller 34 between the bearing 46a and the detection unit 78 toward the upstream side of the transportation direction, the rotational swing at the end portion of the transportation roller 34 can be suppressed. As a result, the vibration-rotation of the rotary scale 80 can be suppressed and the decrease in detection precision of the detection unit 78 can be suppressed.

### Variation on Second Embodiment

1. The configuration of this embodiment is such that the third pressing member 84 presses an end portion of the transportation roller 34 toward the upstream side of the transportation direction. However, in place of this configuration, a configuration in which the third pressing member 84 presses the transportation roller 34 toward the downstream side of the transportation direction may be employed.

2. In this embodiment, the third pressing member 84 has the same configuration as the second pressing member 66, and is so configured as to press an end portion of the transportation roller 34 only toward the upstream side of the transportation direction. However, in place of this configuration, the third pressing member 84 may have the same configuration as the first pressing member 64, and may be so configured as to press the end portion of the transportation roller 34 not only toward the upstream side of the transportation direction, but also toward the upper side of the apparatus height direction.

To summarize the above discussions, the printer 10 of the embodiments includes the recording head 44 configured to record on paper P; the rotatable transportation roller 34 extending in the apparatus width direction, which is a direction intersecting with the paper P transportation direction, with both end portions thereof being supported by the bearings 46a and 46a; the transportation slave rollers 42 configured to nip the paper P between the transportation roller 34 and the transportation slave rollers 42; and the pressing members 62 that are provided at appropriate intervals in the apparatus width direction and serve as regulating members to regulate the shape of the transportation roller 34 between the bearings 46a and 46a to be in a deformed state being arched toward the upstream or downstream side of the transportation direction.

Further, the printer 10 of the embodiments includes the recording head 44 configured to record on paper P; the rotatable transportation roller 34 extending in the apparatus width direction, which is a direction intersecting with the paper P transportation direction, with both the end portions thereof being supported by the bearings 46a and 46a; the transportation slave rollers 42 configured to nip the paper P between the transportation roller 34 and the transportation slave rollers 42; and the pressing members 62 that are provided at appropriate intervals in the apparatus width direction, press the transportation roller 34 between the bearings 46a and 46a, and maintain the transportation roller 34 to be in a deformed state being arched toward the upstream or downstream side of the transportation direction.

Furthermore, the printer 10 of the embodiments includes the recording head 44 configured to record on paper P; the rotatable transportation roller 34 extending in the apparatus width direction, which is a direction intersecting with the paper P transportation direction, with both the end portions thereof being supported by the bearings 46a and 46a; the transportation slave rollers 42 configured to nip the paper P between the transportation roller 34 and the transportation slave rollers 42; and the pressing members 62 that are provided at appropriate intervals in the apparatus width direction and press the transportation roller 34 to shift the rotational center position of the transportation roller 34 at the pressurized sections toward the upstream or downstream side of the transportation direction relative to the rotational center position of the transportation roller 34 at the section of the bearing 46a.

Moreover, the printer 10 of the embodiments includes the recording head 44 configured to record on paper P; the rotatable transportation roller 34 extending in the apparatus width direction, which is a direction intersecting with the paper P transportation direction, with both the end portions thereof being supported by the bearings 46a and 46a; the transportation slave rollers 42 configured to nip the paper P between the transportation roller 34 and the transportation slave rollers 42; and the plurality of pressing members 62 that are provided corresponding to positions where the rotational swing of the transportation roller 34 becomes large in the apparatus width direction during the transportation roller 34 rotating, and press the transportation roller 34 toward the upstream or downstream side of the transportation direction.

In the printer 10, of the plurality of pressing members 62, at least one pressing member 64 biases the transportation roller 34 in a direction resisting the load F1 applied from the transportation slave roller 42.

Further, in the printer 10, the plurality of pressing members 62 include the first pressing member 64 positioned approximately at the center between the bearings 46a and 46a, and the second pressing members 66 positioned on both sides of the first pressing member 64 in the apparatus width direction. The first pressing member 64 presses the transportation roller 34 toward the upstream or downstream side of the transportation direction and also biases the transportation roller 34 in a direction resisting the load F1 applied from the transportation slave roller 42; the second pressing members 66 press the transportation roller 34 toward the upstream side of the transportation direction in the case where the first pressing member 64 presses the transportation roller 34 toward the upstream side of the transportation direction, and press the transportation roller 34 toward the downstream side of the transportation direction in the case where the first pressing member 64 presses the transportation roller 34 toward the downstream side of the transportation direction.

Furthermore, the printer 10 includes the bias units 68 and 74 configured to bias at least one pressing member 64 and one pressing member 66 among the plurality of pressing members 62 toward the upstream or downstream side of the transportation direction, and the contact portions 70 and 76 that make contact with the pressing members 64 and 66 biased by the bias units 68 and 74 so as to regulate the positions of the pressing members 64 and 66 in the transportation direction. The bias units 68 and 74 maintain the state in which the pressing members 64 and 66 are in contact with the contact portions 70 and 76.

In the printer 10, the detection unit 78 for detecting the rotation of the transportation roller 34 is provided at one end portion of the transportation roller 34. At least one of the plurality of pressing members 62 is provided between the detection unit 78 and the bearing 46a supporting the one end portion of the transportation roller 34.

Further, in the printer 10, the transportation roller 34 includes, in the apparatus width direction, the high friction portions 34a that make contact with paper P and transport the paper P with a frictional force generated between the paper P and the high friction portions 34a, and the low friction portions 34b having a lower friction coefficient than the high friction portions 34a and making contact with the pressing members 62. The pressing members 62 press the low friction portions 34b.

Furthermore, in the printer 10, the first pressing member 64 includes the first slope 64a extending toward the upstream side of the transportation direction and also extending in a direction resisting the load F1, and the second slope 64b extending toward the downstream side of the transportation direction and also extending in the direction resisting the load F1.

The first slope 64a and the second slope 64b make contact with the transportation roller 34 to support it in the direction resisting the load F1, and either one of the first slope 64a or the second slope 64b presses the transportation roller 34 toward the upstream or downstream side of the transportation direction.

Although the pressing member 62 according to the invention is applied to an ink jet printer as an example of the recording apparatus in the embodiments, the above pressing member can be applied to other general liquid ejecting apparatuses.

The stated liquid ejecting apparatuses include not only recording apparatuses, such as a printer, copier, facsimile, and the like, that use an ink jet recording head to record on a target recording medium by discharging ink from the recording head, but also include apparatuses that eject a liquid instead of ink in accordance with the usage of the recording from a liquid ejecting head corresponding to the above-mentioned ink jet recording head onto a target ejection medium corresponding to the target recording medium and attach the stated liquid to the target ejection medium.

The following can be cited as liquid ejecting heads in addition to the above-mentioned recording head: that is, a coloring material ejecting head used in the manufacture of color filters for liquid crystal displays and the like, an electrode material (conductive paste) ejecting head used in forming electrodes of organic EL displays, surface emitting displays (FED), and the like, a bioorganic matter ejecting head used in the manufacture of biochips, a sample ejecting head as a precision pipette, and so on.

This invention is not intended to be limited to the above embodiments, and various kinds of variations can be made within the scope of the invention specified in the appended claims; and it is needless to say that such variations are also included within the scope of the invention.

The entire disclosure of Japanese Patent Application No. 2015-094663, filed May 7, 2015 is expressly incorporated by reference herein.

What is claimed is:

1. A recording apparatus comprising:
a recording head configured to record on a target recording medium;
a shaft member that is extended in a direction intersecting with a transportation direction of the target recording medium and is rotatable with both end portions of the shaft member being supported by bearings;
a roller for nipping the target recording medium between the shaft member and the roller; and
pressing members that are provided at appropriate intervals in the direction intersecting with the transportation direction, press the shaft member between the bearings, and maintains the shaft member to be in a deformed state being arched toward an upstream or downstream side of the transportation direction.

2. A recording apparatus comprising:
a recording head configured to record on a target recording medium;
a shaft member that is extended in a direction intersecting with a transportation direction of the target recording medium and is rotatable with both end portions of the shaft member being supported by bearings;
a roller for nipping the target recording medium between the shaft member and the roller; and
pressing members that are provided at appropriate intervals in the direction intersecting with the transportation direction, and press the shaft member to shift a rotational center position of the shaft member at a pressurized portion toward an upstream or downstream side of the transportation direction relative to a rotational center position of the shaft member at a section of the bearings.

3. A recording apparatus comprising:
a recording head configured to record on a target recording medium;
a shaft member that is extended in a direction intersecting with a transportation direction of the target recording medium and is rotatable with both end portions of the shaft member being supported by bearings;
a roller for nipping the target recording medium between the shaft member and the roller; and
a plurality of pressing members that are provided corresponding to positions where a rotational swing of the shaft member becomes large in the direction intersecting with the transportation direction during the shaft member rotating, and press the shaft member toward an upstream or downstream side of the transportation direction.

4. The recording apparatus according to claim 1,
wherein at least one of the plurality of pressing members biases the shaft member in a direction resisting a load applied from the roller.

5. The recording apparatus according to claim 2,
wherein at least one of the plurality of pressing members biases the shaft member in a direction resisting a load applied from the roller.

6. The recording apparatus according to claim 3,
wherein at least one of the plurality of pressing members biases the shaft member in a direction resisting a load applied from the roller.

7. The recording apparatus according to claim 1,
wherein the plurality of pressing members include a first pressing member positioned approximately at the center between the bearings and second pressing members positioned on both sides of the first pressing member in the direction intersecting with the transportation direction,
the first pressing member presses the shaft member toward the upstream or downstream side of the transportation direction and biases the shaft member in a direction resisting a load applied from the roller, and
the second pressing members press the shaft member toward the upstream side of the transportation direction in the case where the first pressing member presses the shaft member toward the upstream side of the transportation direction, and press the shaft member toward the downstream side of the transportation direction in the case where the first pressing member presses the shaft member toward the downstream side of the transportation direction.

8. The recording apparatus according to claim 2,
wherein the plurality of pressing members include a first pressing member positioned approximately at the center between the bearings and second pressing members positioned on both sides of the first pressing member in the direction intersecting with the transporting direction,
the first pressing member presses the shaft member toward the upstream or downstream side of the transportation direction and biases the shaft member in a direction resisting a load applied from the roller, and
the second pressing members press the shaft member toward the upstream side of the transportation direction in the case where the first pressing member presses the shaft member toward the upstream side of the transportation direction, and press the shaft member toward the downstream side of the transportation direction in the case where the first pressing member presses the shaft member toward the downstream side of the transportation direction.

9. The recording apparatus according to claim 3,
wherein the plurality of pressing members include a first pressing member positioned approximately at the center between the bearings and second pressing members positioned on both sides of the first pressing member in the direction intersecting with the transporting direction,
the first pressing member presses the shaft member toward the upstream or downstream side of the transportation direction and biases the shaft member in a direction resisting a load applied from the roller, and
the second pressing members press the shaft member toward the upstream side of the transportation direction in the case where the first pressing member presses the shaft member toward the upstream side of the transportation direction, and press the shaft member toward the downstream side of the transportation direction in the case where the first pressing member presses the shaft member toward the downstream side of the transportation direction.

10. The recording apparatus according to claim 4,
wherein the plurality of pressing members include a first pressing member positioned approximately at the center between the bearings and second pressing members positioned on both sides of the first pressing member in the direction intersecting with the transporting direction,
the first pressing member presses the shaft member toward the upstream or downstream side of the transportation direction and biases the shaft member in a direction resisting a load applied from the roller, and
the second pressing members press the shaft member toward the upstream side of the transportation direction in the case where the first pressing member presses the shaft member toward the upstream side of the transportation direction, and press the shaft member toward the downstream side of the transportation direction in the case where the first pressing member presses the shaft member toward the downstream side of the transportation direction.

11. The recording apparatus according to claim 2,
wherein the plurality of pressing members include a first pressing member positioned approximately at the center between the bearings and second pressing members positioned on both sides of the first pressing member in the direction intersecting with the transporting direction.

12. The recording apparatus according to claim 1, further comprising:
a bias unit configured to bias at least one of the plurality of pressing members toward the upstream or downstream side of the transportation direction; and
a contact portion that makes contact with the pressing member biased by the bias unit and regulates a position of the pressing member in the transportation direction,
wherein the bias unit maintains a state in which the stated pressing member is in contact with the contact portion.

13. The recording apparatus according to claim 2, further comprising:
a bias unit configured to bias at least one of the plurality of pressing members toward the upstream or downstream side of the transportation direction; and
a contact portion that makes contact with the pressing member biased by the bias unit and regulates a position of the pressing member in the transportation direction,
wherein the bias unit maintains a state in which the stated pressing member is in contact with the contact portion.

14. The recording apparatus according to claim 3, further comprising:
a bias unit configured to bias at least one of the plurality of pressing members toward the upstream or downstream side of the transportation direction; and
a contact portion that makes contact with the pressing member biased by the bias unit and regulates a position of the pressing member in the transportation direction,
wherein the bias unit maintains a state in which the stated pressing member is in contact with the contact portion.

15. The recording apparatus according to claim 2,
wherein a detection unit for detecting rotation of the shaft member is provided at one end portion of the shaft member, and
at least one of the plurality of pressing members is provided between the detection unit and the bearing supporting the one end portion of the shaft member.

16. The recording apparatus according to claim 3,
wherein a detection unit for detecting the rotation of the shaft member is provided at one end portion of the shaft member, and
at least one of the plurality of pressing members is provided between the detection unit and the bearing supporting the one end portion of the shaft member.

17. The recording apparatus according to claim 1,
wherein the shaft member includes, in the direction intersecting with the transportation direction, a high friction portion that makes contact with the target recording medium and transports the target recording medium using a frictional force generated between the target recording medium and the high friction portion, and a low friction portion having a lower friction coefficient than the high friction portion and making contact with the pressing member, and
the pressing member presses the low friction portion.

18. The recording apparatus according to claim 2,
wherein the shaft member includes, in the direction intersecting with the transportation direction, a high friction portion that makes contact with the target recording medium and transports the target recording medium using a frictional force generated between the target recording medium and the high friction portion, and a low friction portion having a lower friction coefficient than the high friction portion and making contact with the pressing member, and
the pressing member presses the low friction portion.

19. The recording apparatus according to claim 3,
wherein the shaft member includes, in the direction intersecting with the transportation direction, a high friction portion that makes contact with the target recording medium and transports the target recording medium using a frictional force generated between the target recording medium and the high friction portion, and a low friction portion having a lower friction coefficient than the high friction portion and making contact with the pressing member, and
the pressing member presses the low friction portion.

20. The recording apparatus according to claim 5,
wherein the first pressing member includes a first slope that extends toward the upstream side of the transportation direction and also extends in a direction resisting the aforementioned load and a second slope that extends toward the downstream side of the transportation direction and also extends in the direction resisting the load, and
the first slope and the second slope each make contact with the shaft member and support the shaft member in the direction resisting the load, and one of the first slope and the second slope presses the shaft member toward the upstream or downstream side of the transportation direction.
